(19) United States
(12) Patent Application Publication
(10) Pub. No.: US 2024/0097134 A1
(43) Pub. Date: Mar. 21, 2024

(54) ELECTRODES FOR ENERGY STORAGE DEVICES

(71) Applicant: FastCAP Systems Corporation, Wakefield, MA (US)

(72) Inventor: John Hyde, Ashland, MA (US)

(21) Appl. No.: 18/240,545

(22) Filed: Aug. 31, 2023

Related U.S. Application Data
(60) Provisional application No. 63/403,138, filed on Sep. 1, 2022.

(51) Int. Cl. H01M 4/62; H01M 4/04; H01M 4/133; H01M 4/1393; H01M 4/587; H01M 10/0525

(52) U.S. Cl. CPC H01M 4/622; H01M 4/0404; H01M 4/133; H01M 4/1393; H01M 4/587; H01M 4/625; H01M 10/0525

(57) ABSTRACT

Disclosed herein is an electrode, comprising an active layer comprising a network of high aspect ratio carbon elements defining void spaces within the network; a plurality of electrode active material particles disposed in the void spaces within the network; and a first binder material comprising a water soluble styrene butadiene rubber. Disclosed herein too is a method of manufacturing an active layer comprising mixing together a water soluble styrene butadiene rubber, a plurality of high aspect ratio carbon elements, a plurality of electrode active material particles and a solvent to form a slurry; disposing the slurry on a surface of a metal foil; and drying the slurry to form an active layer.

### CROSS REFERENCE TO RELATED APPLICATIONS

This application claims the benefit of U.S. Application No. 63/403,138, filed on Sep. 1, 2022, which is incorporated herein by reference in its entirety.

### BACKGROUND

Storage devices such as, for example electrical double layer capacitors and batteries are used in many products including medical devices, electric cars, airplanes, and consumer products such as laptop computers, cell phones, and cameras. Due to their high energy densities, high operating voltages, and low-self discharges, lithium ion batteries have overtaken the secondary battery market and continue to find new uses in products and developing industries.

Generally, lithium ion batteries (“LIBs” or “LiBs”) or electrical double layer capacitors comprise an anode, a cathode, and an electrolyte material such as an organic solvent comprising a lithium salt. More specifically, the anode and cathode (collectively, “electrodes”) are formed by mixing either an anode active material or a cathode active material with a binder and a solvent to form a paste or slurry which is then coated and dried on a current collector, such as aluminum or copper, to form a film on the current collector. The anodes and cathodes are then layered or coiled prior to being housed in a pressurized casing containing an electrolyte material, which all together forms a lithium ion battery.

In conventional electrodes, a binder is used with sufficient adhesive, cohesive and chemical properties such that the film coated on the current collector will maintain contact with the current collector even when manipulated to fit into the pressurized battery casing. Since the film contains the electrode active material, there will likely be significant interference with the electrochemical properties of the battery if the film does not maintain sufficient contact with the current collector. Further, it has been important to select a binder that is mechanically compatible with the electrode active material(s) such that it is capable of withstanding the degree of expansion and contraction of the electrode active material(s) during charging and discharging of the battery.

Accordingly, binders such as cellulosic binder or cross-linked polymeric binders have been used to provide good mechanical properties. However, in conventional electrodes binders selected generally require environmentally unfriendly or toxic solvents for processing.

### SUMMARY

Disclosed herein is an electrode, comprising an active layer comprising a network of high aspect ratio carbon elements defining void spaces within the network; a plurality of electrode active material particles disposed in the void spaces within the network; and a first binder material comprising a water soluble styrene butadiene rubber.

Disclosed herein too is a method of manufacturing an active layer comprising mixing together a water soluble styrene butadiene rubber, a plurality of high aspect ratio carbon elements, a plurality of electrode active material particles and a solvent to form a slurry; disposing the slurry on a surface of a metal foil; and drying the slurry to form an active layer.

### BRIEF DESCRIPTION OF THE DRAWINGS

The following is a brief description of the drawings wherein like elements are numbered alike and which are presented for the purposes of illustrating the exemplary embodiments disclosed herein and not for the purposes of limiting the same.

FIG. 1 is a diagram of an electrode according to various embodiments;

FIG. 2 is a flow chart of a method for making an electrode according to various embodiments;

FIG. 3 is a depiction of the electrode arrangement in pouch cell devices; and

FIG. 4 is a depiction of a schematic cutaway diagram showing aspects of an energy storage device (ESD).

### DETAILED DESCRIPTION

A more complete understanding of the components, processes, and apparatuses disclosed herein can be obtained by reference to the accompanying drawings. These figures are merely schematic representations based on convenience and the ease of demonstrating the present disclosure, and are, therefore, not intended to indicate relative size and dimensions of the devices or components thereof and/or to define or limit the scope of the exemplary embodiments. Although specific terms are used in the following description for the sake of clarity, these terms are intended to refer only to the particular structure of the embodiments selected for illustration in the drawings and are not intended to define or limit the scope of the disclosure. In the drawings and the following description below, it is to be understood that like numeric designations refer to components of like function.

Disclosed herein is an electrolytic cell that comprises a housing that comprises electrodes (one or more anodes and one or more cathodes). The housing comprises an electrolyte that contacts each of the anodes and cathodes. Each electrode (the anode and the cathode) comprises a current collector upon which is disposed an active layer. The active layer may be disposed upon an optional adhesive layer that contacts the electrode. The housing comprises a separator material between the electrodes (anode and cathode).

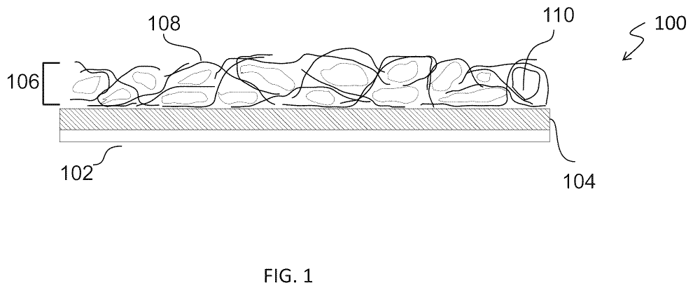

FIG. 1 is a diagram of an electrode (an anode or a cathode) according to various embodiments. In the example shown, electrode 100 is provided. According to various embodiments, electrode 100 comprises current collector 102 and active layer 106. Electrode 100 may optionally include an adhesion layer 104. As an example, adhesion layer 104 comprises a material that promotes adhesion between current collector 102 and active layer 106.

In an embodiment, with regard to the FIG. 1, the electrode (the anode or the cathode) comprises a current collector 102 that is an electrically conductive layer. For example, current collector 102 may be a metal, metal alloy, etc. As another example, current collector 102 is a metal foil. In some embodiments, current collector 102 is an aluminum foil or aluminum alloy foil. In some embodiments, current collector 102 is a copper foil or copper alloy foil. Current collector 102 has a thickness of less than 30 μm. Current collector 102 has a thickness of less than 10 μm. Current collector 102 has a thickness of less than 8 μm. Current collector 102 has a thickness of less than 5 μm. In an embodiment, the current collector 102 has a thickness of 3 to 15 μm. In some preferred embodiments, current collector 102 has a thickness of between about 6 μm and about 8 μm. In some embodiments, current collector 102 is an aluminum foil or an aluminum alloy foil, and current collector 102 has a thickness of about 6 μm.

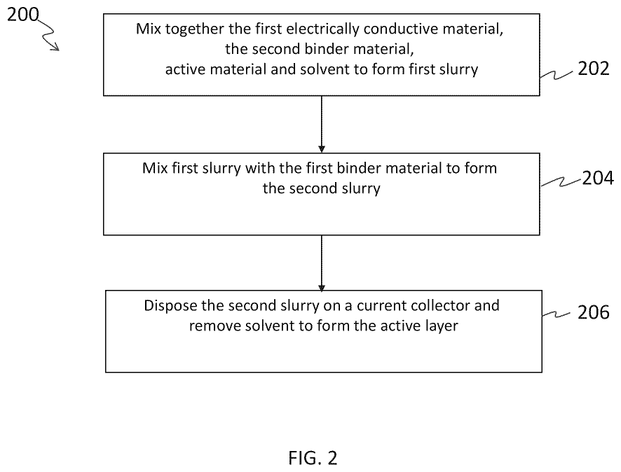

The active layer 106 used in the electrode comprises a first electrically conductive material, a first binder material, a second binder material (the first binder materials and the second binder materials are sometimes referred to as the polymeric binder) and a first active material. FIG. 2 depicts the process 200 by which the electrodes are prepared. The process includes mixing the first electrically conductive material, the second binder material, the first active material and the solvent to form a first slurry 202. The first slurry is mixed using a combination of shear forces, extensional forces and elongational forces to separate some or all of the carbon nanotube bundles. The first slurry can be preserved in a container for as long as desired. When desired, the first slurry 202 may be mixed with the second binder form a second slurry 204. The second slurry 204 is in the form of a gel or paste. The second slurry 204 may be disposed on a current collector and dried to form the active layer 206. In an embodiment, the slurry may be disposed on the current collector or optionally on the adhesive layer to form the active layer.

The first electrically conductive material comprises one or more high aspect ratio carbon elements that comprise a substantially cylindrical network of carbon atoms. The first electrically conductive material comprises a first set of carbon nanotubes or a plurality of bundles of first carbon nanotubes. The first electrically conductive material is sometimes referred to herein (both individually and in combination) as a high aspect ratio carbon element. In an embodiment, the term “high aspect ratio carbon element” refers to carbonaceous elements having a size in one or more dimensions (the “major dimension(s)”) significantly larger than the size of the element in a transverse dimension (the “minor dimension”).

The first electrically conductive material forms an electrically conducting percolating network that can transmit an electrical current between any two separated points located on a surface of the solid active layer (without the solvent in it). In other words, an electrical current can be transmitted from one surface to an opposing surface of the active layer by virtue of physical contacts or electron hopping between the electrically conductive materials in the active layer. The percolating network comprises voids between the high aspect ratio carbon elements that house the active material.

In some embodiments, the active layer includes: (i) a network of high aspect ratio carbon elements defining void spaces within the network, (ii) a plurality of electrode active material particles disposed in the void spaces within the network, and (iii) a polymeric binder, the polymeric binder comprising a styrene-butadiene rubber in latex form. In an embodiment, the polymeric binder further comprises a water soluble cellulose. The first binder material is the styrene-butadiene rubber in latex form. The second binder material is the cellulose.

The first electrically conductive material comprises a high aspect ratio carbon element. The high aspect ratio carbon element can comprise single wall carbon nanotubes (SWCNTs), multiwall carbon nanotubes (MWNTs), or a combination thereof.

In an embodiment, the first electrically conductive material comprises single wall carbon nanotubes. The single wall carbon nanotubes have an outer diameter of 0.5 to 5.0 nanometers, preferably 1.0 to 3.5 nanometers. In an embodiment, the single wall carbon nanotubes have an aspect ratio (length to diameter ratio) greater than about 2.0, preferably greater than 5.0, preferably greater than 10.0, greater than 50 and more preferably greater than 100. In an exemplary embodiment, the single wall carbon nanotubes have an average aspect ratio of 5 to 200.

In an embodiment, the single wall carbon nanotubes have a length greater than 6 nanometers, preferably greater than 10 nanometers, preferably greater than 15 nanometers, preferably greater than 30 nanometers, preferably greater than 50 nanometers, more preferably greater than 100 nanometers, preferably greater than 1 micrometer, preferably greater than 5 micrometers, preferably greater than 10 micrometers, and more preferably greater than 15 micrometers up to at least 200 micrometers. In an exemplary embodiment, the single wall carbon nanotubes have an average length of 100 nanometers (0.1 micrometers) to 20 micrometers, preferably 1 micrometer to 15 micrometers.

In an embodiment, the first electrically conductive material may comprise a high aspect ratio carbon element that is bounded by multiple carbon walls. In an embodiment, the electrically conductive material comprises multiwall carbon nanotubes (MWNTs). The number of carbon walls in the multiwall carbon nanotubes may be 2 or more, 5 or more, 10 or more, 50 or more. According to various embodiments, the multi-wall carbon nanotubes comprise an average of between 3 layers to 15 layers. In some embodiments, the multi-wall carbon nanotubes comprise an average of between 4 layers to 12 layers. In some embodiments, the multi-wall carbon nanotubes comprise an average of between 5 layers to 10 layers. In some embodiments, the multi-wall carbon nanotubes comprise an average of between 6 layers to 7 layers. In some embodiments, the multi-wall carbon nanotubes comprise at least 6 layers on average.

The multiwall carbon nanotubes have an outer diameter of 2 to 50 nanometers, preferably 5 to 40 nanometers, and more preferably 6 to 11 nanometers. In an embodiment, the multiwall carbon nanotubes have an aspect ratio (length to diameter ratio) greater than 5, preferably greater than 10, greater than 50 and more preferably greater than 90 up to an aspect ratio of 4000.

In an embodiment, the multiwall carbon nanotubes have a length greater than 10 nanometers, preferably greater than 15 nanometers, preferably greater than 30 nanometers, preferably greater than 50 nanometers, preferably greater than 100 nanometers, preferably greater than 500 nanometers, preferably greater than 1 micrometer, preferably greater than 5 micrometers, preferably greater than 10 micrometers, and more preferably greater than 15 micrometers. In an exemplary embodiment, the multiwall carbon nanotubes have an average length of 1 micrometer to 20 micrometers.

Combinations of multiwall carbon nanotubes with single wall carbon nanotubes may also be used in the active layer. The embodiments detailed below discuss such embodiments. According to various embodiments, the active layer 106 may comprise a combination of multi-wall carbon nanotubes and single-wall carbon nanotubes. The multi-wall carbon nanotubes swell more than single-wall carbon nanotubes when wetted with an electrolyte in an energy storage device in which electrode 100 is located. In some embodiments, the multi-wall carbon nanotubes swell at least 15% more than single-wall carbon nanotubes when wetted with an electrolyte in an energy storage device in which electrode 100 is located. For example, a length of the multi-wall carbon nanotubes expands at least 15% more than a length of the single-wall carbon nanotubes when wetted with the electrolyte. In some embodiments, the multi-wall carbon nanotubes swell at least 25% more than single-wall carbon nanotubes when wetted with an electrolyte in an energy storage device in which electrode 100 is located. For example, a length of the multi-wall carbon nanotubes expands at least 25% more than a length of the single-wall carbon nanotubes when wetted with the electrolyte. In some embodiments, the multi-wall carbon nanotubes swell at least 50% more than single-wall carbon nanotubes when wetted with an electrolyte in an energy storage device in which electrode 100 is located. For example, a length of the multi-wall carbon nanotubes expands at least 50% more than a length of the single-wall carbon nanotubes when wetted with the electrolyte. In some embodiments, the multi-wall carbon nanotubes swell up to 50% when wetted (e.g., a length of the multi-wall carbon nanotubes is 50% larger after wetting with an electrolyte, and/or a diameter of the multi-wall carbon nanotubes is 50% larger after wetting, etc.).

According to various embodiments, three-dimensional network of high aspect ratio carbon elements 108 comprises carbon nanotubes, and the carbon nanotubes are only multi-wall carbon nanotubes and/or fragment of carbon nanotubes. For example, three-dimensional network of high aspect ratio carbon elements 108 does not include single-wall carbon nanotubes or fragments of single-wall carbon nanotubes. According to various embodiments, three-dimensional network of high aspect ratio carbon elements 108 comprises at least 99% carbon by weight. In some embodiments, three-dimensional network of high aspect ratio carbon elements 108 comprises an electrically interconnected network of carbon elements exhibiting connectivity above a percolation threshold and wherein the network defines one or more highly electrically conductive pathways having a length greater than 100 μm. The percolation threshold is one where the conducting elements contact one another to provide an electrically conducting network measured across any two points on any surface of the network.

According to various embodiments, the electrode comprises multiwall carbon nanotubes that are relatively longer in comparison to multiwall carbon nanotubes contained in related art electrodes. The use of relatively longer multiwall carbon nanotubes in electrodes is found to have beneficial mechanical and/or electrical properties. For example, multiwall carbon nanotubes provide relatively good power at low densities. As another example, shorter multiwall carbon nanotubes generally do not swell (e.g., expand) as much as longer multiwall carbon nanotubes. As such use of shorter multiwall carbon nanotubes loses (or reduces) some of the beneficial properties associated with swelling of the carbon nanotubes. As an extreme example, carbon black does not exhibit swelling because carbon black is merely particles of carbon without entanglement such as the entanglement exhibited by a set of multiwall carbon nanotubes.

An indication that a length of a certain amount of multiwall carbon nanotubes have a length exceeding a threshold length and thus have sufficient swelling properties is an observation during a calendaring process—a relatively larger amount of pressure or effort to calendar the slurry in connection with applying to the foil is indicative that the collective swelling (e.g., an average swelling) of the multiwall carbon nanotubes in the active layer will satisfy a certain performance threshold. However, multiwall carbon nanotubes are generally difficult to process.

According to various embodiments, a distribution of lengths of the set of multiwall carbon nanotubes is skewed towards a nominal length a multiwall carbon nanotube. For example, the multiwall carbon nanotubes are processed and/or applied in a manner that reduces or minimizes fracturing or breaking of multiwall carbon nanotubes. The lengths of the multiwall carbon nanotubes in the network of high aspect ratio carbon elements are generally the nominal length of the multiwall carbon nanotubes, or a length of such the multiwall carbon nanotubes tend to be more heavily skewed to the nominal length.

In some embodiments, at least 75% of the multiwall carbon nanotubes within the network of high aspect ratio carbon elements are within 10% of the nominal length (e.g., between 13.4 micrometers to about 15 micrometers). In some embodiments, at least 75% of the multiwall carbon nanotubes within the network of high aspect ratio carbon elements have a length of at least 12 micrometers. In some embodiments, at least 75% of the multiwall carbon nanotubes within the network of high aspect ratio carbon elements have a length of at least 13 micrometers. In some embodiments, at least 50% of the multiwall carbon nanotubes within the network of high aspect ratio carbon elements are within 10% of the nominal length (e.g., between 13.4 micrometers to about 15 micrometers). In some embodiments, at least 50% of the multiwall carbon nanotubes within the network of high aspect ratio carbon elements have a length of at least 12 micrometers. In some embodiments, at least 50% of the multiwall carbon nanotubes within the network of high aspect ratio carbon elements have a length of at least 13 micrometers.

In a preferred embodiment, the first electrically conductive material used in the active layer are multiwall carbon nanotubes.

The high aspect ratio carbon elements (e.g., single wall carbon nanotubes, multiwall carbon nanotubes, or a combination thereof) are present in the first slurry (the first slurry comprises the first electrically conductive material, the second binder material, the first active material and the solvent) in an amount of 4.5 to 6 wt % and preferably 5 to 5.75 wt %, based on the entire weight of the first slurry.

The high aspect ratio carbon elements are present in the second slurry (the second slurry comprises the first electrically conductive material, the first binder material, the second binder material, the first active material and the solvent) in an amount of 5 to 7 wt %, preferably 5.25 to 6.25 wt % based on the total weight of the second slurry. The high aspect ratio carbon elements are present in the active layer in an amount of 8 to 12 wt %, based on the total weight of the active layer.

As noted above, the high aspect ratio carbon elements are preferably multiwall carbon nanotubes.

In an embodiment, the first and second slurries can comprise a second electrically conductive material. The second electrically conductive material is different from the first electrically conductive material in structure or in composition. The second electrically conductive material is preferably carbonaceous and comprises at least one of carbon black, graphite flakes, single wall carbon nanotubes, multiwall carbon nanotubes, or a combination thereof. For example, if the first electrically conductive material contains carbon nanotubes (e.g., single and/or multiwall carbon nanotubes), then the second electrically conductive material can comprise carbon black, graphite flakes, or a combination thereof. In another example, if the first electrically conductive material contains single wall carbon nanotubes, then the second electrically conductive material may contain one of multiwall carbon nanotubes, carbon black, graphite flakes, or a combination thereof. The second electrically conductive material may be present in the active layer (after removal of the solvent) in an amount of 0.5 to 10 wt %, preferably 1 to 5 wt %, based on the total weight of the active layer.

The first binder material comprises a first polymer that is at least soluble in water. In an embodiment, the first binder material comprises a random copolymer or a block copolymer of an alkenyl aromatic compound and a conjugated diene. For brevity, this component is referred to as the “copolymer”. The copolymer generally comprises 10 to 55 weight percent poly(alkenyl aromatic) content, based on the weight of the copolymer. Within this range, the poly(alkenyl aromatic) content can be 20 to 50 weight percent, specifically 25 to 45 weight percent.

In some embodiments, the copolymer has a weight average molecular weight of at least 100,000 atomic mass units. In some embodiments the copolymer comprises a polystyrene-poly(butadiene)-polystyrene diblock or triblock copolymer having a weight average molecular weight of 20,000 to 1,000,000 grams per mole, specifically 50,000 to 400,000 grams per mole. In some embodiments the copolymer comprises a styrene-butadiene random copolymer having a weight average molecular weight of 20,000 to 1,000,000 grams per mole, specifically 50,000 to 400,000 grams per mole.

The alkenyl aromatic monomer used to prepare the copolymer can have the structure

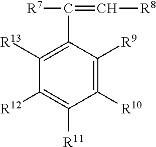

wherein R⁷ and R⁸ each independently represent a hydrogen atom, a C₁-C₈ alkyl group, or a C₂-C₈ alkenyl group; R⁹ and R¹³ each independently represent a hydrogen atom, a C₁-C₈ alkyl group, a chlorine atom, or a bromine atom; and R¹⁰, R¹¹, and R¹² each independently represent a hydrogen atom, a C₁-C₈ alkyl group, or a C₂-C₈ alkenyl group, or R¹⁰ and R¹¹ are taken together with the central aromatic ring to form a naphthyl group, or R¹¹ and R¹² are taken together with the central aromatic ring to form a naphthyl group. Specific alkenyl aromatic monomers include, for example, styrene, chlorostyrenes such as p-chlorostyrene, methylstyrenes such as alpha-methyl styrene and p-methyl styrene, and t-butylstyrenes such as 3-t-butylstyrene and 4-t-butylstyrene. In some embodiments, the alkenyl aromatic monomer is styrene.

The conjugated diene used to prepare the copolymer can be a C₄-C₂₀ conjugated diene. Suitable conjugated dienes include, for example, 1,3-butadiene, 2-methyl-1,3-butadiene, 2-chloro-1,3-butadiene, 2,3-dimethyl-1,3-butadiene, 1,3-pentadiene, 1,3-hexadiene, and the like, and combinations thereof. In some embodiments, the conjugated diene is 1,3-butadiene, 2-methyl-1,3-butadiene, or a combination thereof. In some embodiments, the conjugated diene consists of 1,3-butadiene.

The copolymer is a copolymer comprising (A) at least one block derived from an alkenyl aromatic compound and (B) at least one block derived from a conjugated diene, in which the aliphatic unsaturated group content in the block (B) is at least partially reduced by hydrogenation. In some embodiments, the aliphatic unsaturation in the (B) block is reduced by at least 50 percent, specifically at least 70 percent. The arrangement of blocks (A) and (B) includes a linear structure, a grafted structure, and a radial teleblock structure with or without a branched chain. Linear block copolymers include tapered linear structures and non-tapered linear structures. In some embodiments, the block copolymer is a diblock copolymer, a triblock copolymer, or a combination thereof. In some embodiments, the copolymer is a random copolymer.

In some embodiments, the block copolymer excludes the residue of monomers other than the alkenyl aromatic compound and the conjugated diene. In some embodiments, the block copolymer consists of blocks derived from the alkenyl aromatic compound and the conjugated diene, where at least one of the blocks is carboxylated (i.e., is grafted with a carboxylic acid or with a derivative of a carboxylic acid). Examples of unsaturated carboxylic acids are maleic acid, fumaric acid, itaconic acid, methacrylic acid, crotonic acid, malonic acid, succinic acid, glutaric acid, adipic acid, pimelic acid, suberic acid, azelaic acid, sebacic acids, citraconic acid, or the like, or a combination thereof. Examples of derivatives of unsaturated carboxylic acids are maleic anhydride, citraconic anhydride, itaconic anhydride, malonic anhydride, succinic anhydride, glutaric anhydride, adipic anhydride, pimelic anhydride, suberic anhydride, azelaic anhydride, methyl acrylate, methyl methacrylate, ethyl acrylate, ethyl methacrylate, butyl acrylate, butyl methacrylate, glycidyl acrylate, glycidyl methacrylate, or the like, or a combination thereof. Maleic anhydride is the preferred grafting compound.

Carboxylation of the block copolymer permits the styrene-butadiene copolymer to be used in latex form, where it is present in small particles dispersed in water. A latex is a dispersion of polymeric particles or droplets in liquid. The particles do not sink or float in a water-based emulsion, nor do they coagulate due to ionic or steric instability. Ionic stability is the result of ionic charges on particles, producing a repulsive force that prevents agglomeration. Steric stability arises when the surfaces of polymer particles extend into the solution, keeping the particles apart physically. Additives can be put into a latex to ensure its steric stability and bolster its resistance to coagulation.

In a preferred embodiment, the first polymer is a styrene-butadiene random copolymer. In an embodiment, the styrene-butadiene block copolymer is added to the slurry in latex form.

The first binder material is present in the second slurry only. As noted above, the second slurry comprises the first electrically conductive material, the first binder material, the second binder material, the first active material and the solvent. The first slurry becomes the second slurry upon adding the first binder material. The first binder material is present in the second slurry in an amount of 4.5 to 6.5 wt %, preferably 5 to 6 wt % based on the total weight of the second slurry. The first binder is present in the active layer in an amount of 7 to 13 wt %, preferably 8 to 12 wt %, based on the weight of the active layer.

The second binder material present in the active layer is also a water soluble polymer. The second binder material is chemically different from the first binder material. In an embodiment, the second binder material is a water soluble, naturally occurring polymer. Examples of naturally occurring polymers for use as the second binder material includes cellulose and cellulose derivatives (e.g., hydroxymethylcellulose, hydroxyethylcellulose, hydroxypropylcellulose, hydroxypropyl methylcellulose, carboxymethyl cellulose (CMC), sodium carboxymethyl cellulose, cellulose acetate, cellulose diacetate, cellulose triacetate, cellulose propionate, cellulose acetate butyrate, and cellulose ethers like ethyl cellulose, or the like, or a combination thereof), sugars (glucose, sucrose, lactose, galactose, fructose, mannitol, sorbitol, or a combination thereof), ionic complexes of celluloses (gums (e.g., acacia, alginate, carrageenan, guar, karaya, pectin, tragacanth, xanthan, or the like, or a combination thereof).

In a preferred embodiment, the second binder is carboxymethyl cellulose (CMC).

The second binder is present in an amount of 2 to 4 wt %, preferably 2.25 to 3.75 wt %, based on the total weight of the first slurry. The second binder is present in an amount of 2.25 wt % to 5 wt %, preferably 2.35 to 4.6 wt %, based on the total weight of the second slurry. The second binder is present in the active layer in an amount of 3 to 7 wt %, based on the weight of the active layer.

The active material for use in the active layer 106 (see FIG. 1) is located in voids encompassed by the electrically conductive network formed by the high aspect ratio carbon elements. The active layer may comprise other activated carbonaceous materials including, for example, activated carbon granules, activated carbon fibers, activated carbon nanotubes, carbon aerogels, or a combination thereof. Other active materials that can be used in the active layer includes lithium cobalt oxide (LCO), lithium nickel manganese cobalt oxide (LiNiMnCo), lithium manganese oxide (LMO), lithium titanate oxide (LTO), lithium iron phosphate oxide (LFP), lithium nickel cobalt aluminum oxide (LiNiCoAlO) as well as other similar other materials.

Activated carbon is generally a form of carbon that has been physically or chemically processed to increase its porosity and surface area available for adsorption and chemical reactions. Powdered activated carbon (PAC) and granular activated carbon (GAC) are among common forms. In an embodiment, the active material is an activated powdered carbon. Activated carbon can have a surface area of 500 to 3,000 square meters per gram.

In an embodiment, the active material used in both electrodes (anode and/or cathode) may include lithium cobalt oxide (LCO, sometimes called “lithium cobaltate” or “lithium cobaltite,”. One variant of possible LCO formulations is LiCoO₂); lithium nickel manganese cobalt oxide (NMC, with a variant formula of LiNiMnCo); lithium manganese oxide (LMO with variant formulas of LiMn₂O₄, Li₂MnO₃ or the like, or a combination thereof); lithium titanate oxide (LTO, with one variant formula being Li₄Ti₅O₁₂); lithium iron phosphate oxide (LFP, with one variant formula being LiFePO₄), lithium nickel cobalt aluminum oxide (and variants thereof as NCA) as well as other similar other materials. Other variants of the foregoing may be included. In some embodiments where NMC is used as an active material, nickel rich NMC may be used. In some embodiments, where NMC is used as an active material, nickel rich NMC may be used.

For example, in some embodiments, the variant of NMC may be LiNiₓMn_{y}Co_{(1-x-y)}, where x is equal to or greater than about 0.7, 0.75, 0.80, 0.85 or more. In an embodiment, y may be equal to or greater than 0.1, 0.15, 0.2 or 0.25. In some embodiments, NMC811 may be used where x is about 0.8 and y is about 0.1.

In some embodiments, the active material includes other forms of lithium nickel manganese cobalt oxide (LiNiₓMn_{y}Co_{z}O₂). Variants of this formula that may be used in the active material layer include NMC 111 (detailed below), NMC532 (LiNi_{0.5}Mn_{0.3}Co_{0.2}O₂), NMC622 (LiNi_{0.6}Mn_{0.2}Co_{0.2}O₂), or a combination thereof.

In an embodiment, the active material used in both electrodes (anode and/or cathode) may also include a nickel-rich combination of nickel, manganese, and cobalt. Lithium-Nickel-Manganese-Cobalt-Oxide (LiNiMnCoO₂), abbreviated as NMC delivers strong overall performance, excellent specific energy, and the lowest self-heating rate of all mainstream cathode powders. The NMC powder may comprise nickel in an amount of 20 to 40 wt %, manganese in an amount of 20 to 40 wt % and cobalt in an amount of 20 to 40 wt %, based on a total weight of the NMC blend. While the term “NMC powder” can refer to a variety of blends, it is desirable to use a blend that comprises 33 wt % nickel, 33 wt % manganese and 33 wt % cobalt. This blend, sometimes referred to as 1-1-1 (NMC 111) is useful for applications that use frequent cycling (automotive, energy storage) due to the reduced material cost resulting from lower cobalt content.

The active material is contained in the active layer in an amount of 67 to 85 wt %, preferably 70 to 80 wt %, based on the total weight of the active layer.

The mixture for manufacturing the active layer further contains a solvent. The solvent is preferably one that is used to disperse the first binder, the second binder, the first electrically conductive material and the second conductive material to form the mixture. The mixture is then disposed on the current collector to form the active layer.

Suitable solvents are water, alcohol, or a combination thereof. Examples of alcohol are ethanol, methanol, propanol, butyl alcohol, ethylene glycol, propylene glycol, or a combination thereof. In addition to water and alcohol, other solvents may be added to facilitate solubilization and/or dispersion of the polymer. Other solvents include polar solvents, non-polar solvents, and the like. The addition of other solvents should preferably not change the solubility of the polymer in the water or alcohol. Liquid aprotic polar solvents such as propylene carbonate, ethylene carbonate, butyrolactone, acetonitrile, benzonitrile, nitromethane, nitrobenzene, sulfolane, dimethylformamide, N-methylpyrrolidone, or the like, or combinations thereof may be added to water or alcohol for dissolution of the polymer. Polar protic solvents such acetonitrile, nitromethane, acetone, dimethyl sulfoxide, dimethylformamide, or the like, or a combination thereof may be used. Other non-polar solvents such a benzene, toluene, methylene chloride, carbon tetrachloride, hexane, diethyl ether, tetrahydrofuran, or the like, or a combination thereof may also be used. Co-solvents comprising at least one aprotic polar solvent and at least one non-polar solvent may also be utilized to modify the solubilization power of the solvent.

In a preferred embodiment, the solvent is water. In another preferred embodiment, the solvent is alcohol. When water and alcohol are used as the solvents for the active layer the ratio of water to alcohol is 80:20 to 95:5, preferably 88:12 to 92:8. In an exemplary embodiment, the ratio of water to alcohol is 90:10.

The solvent is present in an amount of 45 to 60 wt %, preferably 48 to 55 wt %, based on the total weight of the first slurry. The solvent is preferably removed from the active layer after it is disposed on the current collector. The solid active layer preferably is free of solvent (water and alcohol).

The active layer 106 has an average thickness of between 20 microns and 200 microns. In some embodiments, active layer 106 has an average thickness of 20 microns to 30 microns. In some embodiments, active layer 106 has an average thickness of about 100 microns.

According to various embodiments, the active layer 106 expands (e.g., swells) less than 10% when wetted with an electrolyte. For example, the thickness of active layer 106 (after wetting with an electrolyte) is less than 110% of the thickness of active layer 106 in the absence of the electrolyte.

In an embodiment, the cathode polymeric binders (the first and second cathode polymeric binders), the cathode active material, the cathode conductive material and the solvent are blended together to form the cathode mixture, which is in the form of a slurry. The blending process facilitates dispersion of the cathode conductive material and the cathode active material to form a percolating network through the volume of the cathode active layer when the solvent is removed. In an embodiment, the cathode mixture (in slurry form) is disposed on a current collector after the mixing is completed. The current collector with the cathode mixture disposed thereon is subjected to shear and compression in a roll mill. The use of a roll mill facilitates bonding of the cathode active layer to the current collector.

FIG. 2 is a flow chart of a method for making an electrode according to various embodiments. The description of process 200 is provided with respect to electrode 100 of FIG. 1. Referring to FIG. 2, in some embodiments, the active layer 106 of electrode 100 may be formed using process 200. At 202, high aspect ratio carbon elements (e.g., the MWNTs), the second binder (e.g., the CMC) and the active material (e.g., the activated carbon) and any optional surface treatment materials (e.g., a surfactant) are combined with a solvent (of the type described herein) to form an initial slurry (also called a first slurry).

At 202, the first slurry is processed to ensure good dispersion of the solid materials in the slurry. In some embodiments, this processing includes introducing mechanical energy into the mixture of solvent and solid materials (e.g., using a sonicator, which may sometimes also be referred to as a “sonifier”) or other suitable mixing device (e.g., a high shear mixer). In some embodiments, the mechanical energy introduced into the mixture is at least 0.4 kilowatt-hours per kilogram (kWh/kg), 0.5 kWh/kg, 0.6 kWh/kg, 0.7 kWh/kg, 0.8 kWh/kg, 0.9 kWh/kg, 1.0 kWh/kg, or more. For example, the mechanical energy introduced into the mixture per kilogram of mixture may be in the range of 0.4 kWh/kg to 1.0 kWh/kg or any subrange thereof such as 0.4 kWh/kg to 0.6 kWh/kg.

In some embodiments an ultrasonic bath mixer may be used. In other embodiments, a probe sonicator may be used. Probe sonication may be significantly more powerful and effective when compared to ultrasonic baths for nanoparticle applications. High shear forces created by ultrasonic cavitation have the ability to break up particle agglomerates and result in smaller and more uniform particles sizes. Among other things, sonication can result in stable and homogenous suspensions of the solids in the slurry. Generally, this results in dispersing and deagglomerating and other breakdown of the solids. Examples of probe sonication devices include the Q Series Probe Sonicators available from QSonica LLC of Newtown, Connecticut. Another example includes the Branson Digital SFX-450 sonicator available commercially from Thomas Scientific of Swedesboro, New Jersey.

In some embodiments, however, the localized nature of each probe within the probe assembly can result in uneven mixing and suspension. Such may be the case, for example, with large samples. This may be countered by use of a setup with a continuous flow cell and proper mixing. For example, with such a setup, mixing of the slurry will achieve reasonably uniform dispersion.

In some embodiments the first slurry, once processed will have a viscosity in the range of 2,000 cps to 25,000 cps or any subrange thereof, e.g., 6,000 cps to 19,000 cps.

The first slurry is then mixed with the first binder material (e.g., the SBR latex) to form the final slurry.

At 204, the final slurry is processed to ensure good dispersion of the solid materials in the final slurry. In various embodiments any suitable mixing process known in the art may be used. In some embodiments this processing may use the techniques described above with reference to 202. In some embodiments, a planetary mixer such as a multi-axis (e.g., three or more axis) planetary mixer may be used. In some such embodiments the planetary mixer can feature multiple blades, e.g., two or more mixing blades and one or more (e.g., two, three, or more) dispersion blades such as disk dispersion blades.

In some embodiments, during 204, the matrix enmeshing the active material may fully or partially self-assemble. In some embodiments, interactions between the surface treatment and the active material promote the self-assembly process.

In some embodiments the final slurry, once processed will have a viscosity in the range of 1,000 cps to 10,000 cps or any subrange thereof, e.g., 2,500 cps to 6000 cps.

At 206, the active layer 106 is formed from the final slurry. In some embodiments, the final slurry may be cast wet directly onto the current collector conductive layer 102 (or optional adhesion layer 104) and dried. As an example, casting may be by applying at least one of heat and a vacuum until substantially all of the solvent and any other liquids have been removed, thereby forming the active layer 106. In some such embodiments, protecting various parts of the underlying layers may be desirable. For example, protecting an underside of the conductive layer 102 may be desirable where the electrode 100 is intended for two-sided operation. Protection may include, for example, protection from the solvent by masking certain areas, or providing a drain to direct the solvent away.

In other embodiments, the final slurry may be at least partially dried elsewhere and then transferred onto the adhesion layer 104 or the conductive layer 102 to form the active layer 106, using any suitable technique (e.g., roll-to-roll layer application). In some embodiments the wet final slurry may be placed onto an intermediate material with an appropriate surface and dried to form the layer (e.g., the active layer 106). While any material with an appropriate surface may be used as the intermediate material, exemplary intermediate material includes PTFE as subsequent removal from the surface is facilitated by the properties thereof. In some embodiments, the designated layer is formed in a press to provide a layer that exhibits a desired thickness, area and density.

In some embodiments, the final slurry may be formed into a sheet, and coated onto the adhesion layer 104 or the conductive layer 102 as appropriate. For example, in some embodiments, the final slurry may be applied to through a slot die to control the thickness of the applied layer. In other embodiments, the slurry may be applied and then leveled to a desired thickness, e.g., using a doctor blade. A variety of other techniques may be used for applying the slurry. For example, coating techniques may include, without limitation: comma coating; comma reverse coating; doctor blade coating; slot die coating; direct gravure coating; air doctor coating (air knife); chamber doctor coating; off set gravure coating; one roll kiss coating; reverse kiss coating with a small diameter gravure roll; bar coating; three reverse roll coating (top feed); three reverse roll coating (fountain die); reverse roll coating and others.

The viscosity of the final slurry may vary depending on the application technique. For example, for comma coating, the viscosity may range between about 1,000 cps to about 200,000 cps. Lip-die coating provides for coating with slurry that exhibits a viscosity of between about 500 cps to about 300,000 cps. Reverse-kiss coating provides for coating with slurry that exhibits a viscosity of between about 5 cps and 1,000 cps. In some applications, a respective layer may be formed by multiple passes.

In some embodiments, the active layer 106 formed from the final slurry may be compressed (e.g., using a calendaring apparatus) before or after being applied to the electrode 100. In some embodiments, the slurry may be partially or completely dried (e.g., by applying heat, vacuum or a combination thereof) prior to or during the compression process. For example, in some embodiments, the active layer may be compressed to a final thickness (e.g., in the direction normal to the current collector layer 102) of less than 90%, 80%, 70%, 50%, 40%, 30%, 20%, 10% or less of its pre-compression thickness.

In various embodiments, when a partially dried layer is formed during a coating or compression process, the layer may be subsequently fully dried, (e.g., by applying heat, vacuum or a combination thereof). In some embodiments, substantially all of the solvent is removed from the active layer 106.

In some embodiments, solvents used in formation of the slurries are recovered and recycled into the slurry-making process.

In some embodiments, active layer 106 may be compressed, e.g., to break some of the constituent high aspect ratio carbon elements or other carbonaceous material to increase the surface area of the respective layer. In some embodiments, this compression treatment may increase one or more of adhesion between the layers, ion transport rate within the layers, and the surface area of the layers. In various embodiments, compression can be applied before or after the respective layer is applied to or formed on the electrode 100.

In some embodiments where calendaring is used to compress active layer 106, the calendaring apparatus may be set with a gap spacing equal to less than 90%, 80%, 70%, 50%, 40%, 30%, 20%, 10% or less of the layer's pre-compression thickness (e.g., set to about 33% of the layer's pre-compression thickness). The calendar rolls can be configured to provide suitable pressure, e.g., greater than 1 ton per cm of roll length, greater than 1.5 ton per cm of roll length, greater than 2.0 ton per cm of roll length, greater than 2.5 ton per cm of roll length, or more. In some embodiments, the post compression active layer will have a density in the range of 0.1 g/cc to 10 g/cc, or any subrange thereof such as 2.5 g/cc to 4.0 g /cc.

In some embodiments the calendaring process may be carried out at a temperature in the range of 20° C. to 140° C. or any subrange thereof. In some embodiments active layer 106 may be pre-heated prior to calendaring, e.g., at a temperature in the range of 20° C. to 100° C. or any subrange thereof.

Once the electrode 100 has been assembled, the electrode 100 may be used to assemble the energy storage device. Assembly of the energy storage device may follow conventional steps used for assembling electrodes with separators and placement within a housing such as a canister or pouch, and further may include additional steps for electrolyte addition and sealing of the housing.

In various embodiments, process 200 may include any of the following features (individually or in any suitable combination)

In some embodiments, the initial slurry has a solid content in the range of 0.1%-20.0% (or any subrange thereof) by weight. In some embodiments, the final slurry has a solid content in the range of 10.0%-80% (or any subrange thereof) by weight.

The 3D carbon scaffold or matrix holds active material particles together to form a cohesive layer that is also strongly attached to the metallic current collector. Such active material structure is created during slurry preparation and subsequently in a roll to roll (“R2R”) coating and drying process. One of the main advantages of this technology is its scalability and “drop-in” nature because various embodiments are compatible with conventional electrode manufacturing processes.

The teachings herein provide a 3D matrix that dramatically boosts electrode conductivity by a factor of 10× to 100× compared to electrodes using conventional binders such as PVDF, which enables fast charging at a battery level. Thick electrode coatings in cathode up to 150 μm per side (or more) of current collector are possible with this technology. The solvents used in the slurry in combination with a strong 3D carbon matrix are designed to achieve thick wet coatings without cracking during the drying step. Thick cathodes with high capacity anodes are what enable a substantial jump in energy density reaching 400 Wh/kg or more.

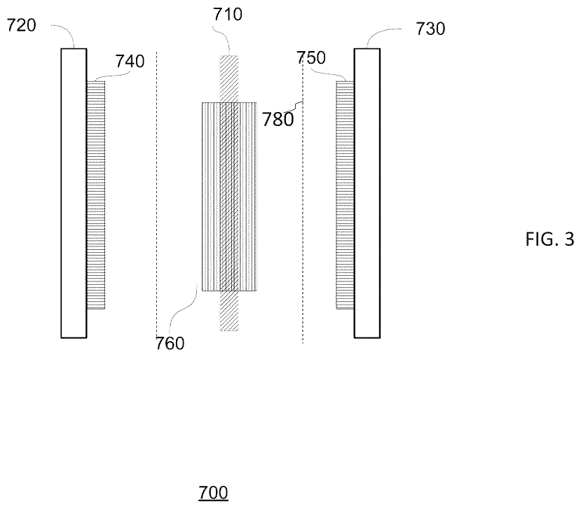

A schematic of the electrode arrangement pouch cell devices is shown in FIG. 3. As shown, a double-sided cathode 700 using cathode layers 760 (e.g., active layers according to various embodiments disclosed herein) on opposing sides of an aluminum foil current collector 710 are disposed between two single sided anodes 720 and 730 each having an anode layer 740 and 750 (e.g., an active layer comprising a network of carbon elements such as disclosed herein) disposed on a copper foil current collector. The electrodes are separated by permeable separator material 780 wetted with electrolyte (not shown). The arrangement can be housed in a pouch cell of the type well known in the art.

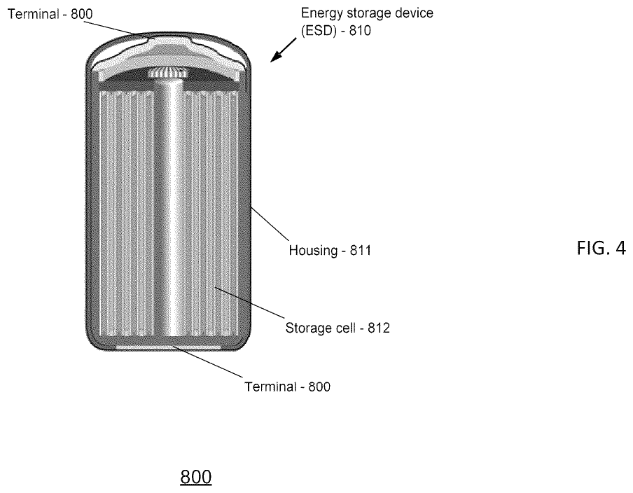

In FIG. 4, a cross section of an energy storage device (ESD) 810 is shown. The energy storage device (ESD) 810 includes a housing 811. The housing 811 has two terminals 800 disposed on an exterior thereof. The terminals 800 provide for internal electrical connection to a storage cell 812 contained within the housing 811 and for external electrical connection to an external device such as a load or charging device (not shown). The energy storage devices disclosed herein may be batteries, capacitors, ultracapacitors, or the like.

The materials and the structures disclosed herein are exemplified by the following non-limiting examples.

While the invention has been described with reference to some embodiments, it will be understood by those skilled in the art that various changes may be made and equivalents may be substituted for elements thereof without departing from the scope of the invention. In addition, many modifications may be made to adapt a particular situation or material to the teachings of the invention without departing from essential scope thereof. Therefore, it is intended that the invention not be limited to the particular embodiments disclosed as the best mode contemplated for carrying out this invention, but that the invention will include all embodiments falling within the scope of the appended claims.

What is claimed is:

1. An electrode, comprising:
an active layer comprising:
a network of high aspect ratio carbon elements defining void spaces within the network;
a plurality of electrode active material particles disposed in the void spaces within the network; and
a first binder material comprising a water soluble styrene butadiene rubber.

2. The electrode of claim 1, wherein the network of high aspect ratio carbon elements comprises multiwall carbon nanotubes.

3. The electrode of claim 2, wherein the multiwall carbon nanotubes have average diameters of 6 to 12 nanometers and average lengths of 1 to 20 micrometers.

4. The electrode of claim 3, wherein the multiwall carbon nanotubes are present in the active layer in an amount of 8 to 12 wt %, based on the total weight of the active layer.

5. The electrode of claim 1, wherein the electrode active material particles comprise activated carbon.

6. The electrode of claim 5, wherein the activated carbon is selected from the group consisting of activated carbon granules, activated carbon powder, activated carbon fibers, activated carbon nanotubes, or a combination thereof.

7. The electrode of claim 6, wherein the activated carbon is present in the active layer in an amount of 67 to 85 wt %, based on the total weight of the active layer.

8. The electrode of claim 7, wherein the activated carbon is present in the active layer in an amount of 70 to 80 wt %, based on the total weight of the active layer.

9. The electrode of claim 1, wherein the active layer comprises a second binder material that contains cellulose.

10. The electrode of claim 9, wherein the cellulose is carboxymethylcellulose.

11. The electrode of claim 9, wherein second binder is present in the active layer in an amount of 3 to 7 wt %, based on the weight of the active layer.

12. The electrode of claim 1, wherein the styrene butadiene rubber is present in the active layer in an amount of 7 to 13 wt %, based on the weight of the active layer.

13. The electrode of claim 1, wherein the styrene butadiene rubber is present in the active layer in an amount of 8 to 12 wt %, based on the weight of the active layer.

14. The electrode of claim 1, wherein the styrene butadiene rubber is in the form a latex.

15. An energy storage device comprising:
an electrolyte; and
the electrode of claim 1, wherein the multi-wall nanotubes form a percolating network through the active layer.

16. A method of manufacturing an active layer comprising:
mixing together a water soluble styrene butadiene rubber, a plurality of high aspect ratio carbon elements, a plurality of electrode active material particles and a solvent to form a slurry;
disposing the slurry on a surface of a metal foil; and
drying the slurry to form an active layer.

17. The method of claim 16, further comprising mixing a cellulose into the slurry.

18. The method of claim 17, wherein the solvent is water.

19. The method of claim 16, wherein the high aspect ratio carbon elements define a network with void spaces in the network; where the plurality of electrode active material particles are contained in the void spaces.

20. The method of claim 16, wherein the wherein the styrene butadiene rubber is in the form a latex.
